(19) United States
(12) Patent Application Publication
(10) Pub. No.: US 2022/0180359 A1
(43) Pub. Date: Jun. 9, 2022

(54) METHOD, APPARATUS, AND ELECTRONIC DEVICE FOR DATA PROCESSING, AND COMPUTER-READABLE STORAGE MEDIUM

(71) Applicant: TENCENT TECHNOLOGY (SHENZHEN) COMPANY LIMITED, Shenzhen (CN)

(72) Inventors: Jian Keng PENG, Shenzhen (CN); Na He, Shenzhen (CN); Zheng Ye Liu, Shenzhen (CN); Tian Xin Lin, Shenzhen (CN)

(73) Assignee: TENCENT TECHNOLOGY (SHENZHEN) COMPANY LIMITED, Shenzhen (CN)

(21) Appl. No.: 17/683,674

(22) Filed: Mar. 1, 2022

Related U.S. Application Data
(63) Continuation of application No. PCT/CN2020/126935, filed on Nov. 6, 2020.

(30) Foreign Application Priority Data
Feb. 18, 2020 (CN) 202010100281.3

(51) Int. Cl. G06Q 20/40; H04L 67/306

(52) U.S. Cl. CPC G06Q 20/401; H04L 67/306

(57) ABSTRACT

A method, an apparatus, and an electronic device for data processing, and a computer-readable storage medium are provided. The method includes: generating unique identification information associated with a user account; transmitting the unique identification information to the user account; receiving, from a server associated with an institution which verifies identity information corresponding to the user account, the unique identification information and a non-payment service request related to the user account; and identifying the user account based on the unique identification information, and providing the user account with a non-payment service based on the non-payment service request.

### CROSS-REFERENCE TO RELATED APPLICATION(S)

This application is a continuation application of International Application No. PCT/CN2020/126935, filed Nov. 6, 2020, which claims priority to Chinese Patent Application No. 202010100281.3, filed on Feb. 18, 2020 with the China National Intellectual Property Administration, the disclosures of which are incorporated by reference in their entireties.

### FIELD

The disclosure relates to Internet technologies, and specifically, to a method, an apparatus, and an electronic device for data processing, and a computer-readable storage medium.

### BACKGROUND

With the high development of Internet technologies, online payment services provided by payment institutions are widely used and have high importance. Moreover, with increasingly frequent international exchanges, more and more overseas users have the demand for cross-border online payment.

However, in the related art, for online payment deployed in a country or region, a user who is overseas needs to apply for a bank card of a bank in that country in advance, and the payment services may be used only when the bank card is bound to an account of the payment institution.

However, due to the particularity of overseas users, laws and regulations of most countries impose restriction and complexity to the process for overseas users to apply for a domestic bank card. Overseas users may not even be able to complete the application for a bank card in the country the payment instructions belong to, making it impossible for overseas users to receive the payment services provided by the payment institutions.

### SUMMARY

Example embodiments of the disclosure provide a method, an apparatus, and an electronic device for data processing, and a computer-readable storage medium, which may bring more convenience for overseas users to receive payment services and non-payment services provided by payment institutions.

According to an aspect of an example embodiment, there is provided a method for data processing, performed by at least one processor, the method including: generating unique identification information associated with a user account; transmitting the unique identification information to the user account; receiving, from a server associated with an institution which verifies identity information corresponding to the user account, the unique identification information and a non-payment service request related to the user account; and identifying the user account based on the unique identification information, and providing the user account with a non-payment service based on the non-payment service request.

According to an aspect of an example embodiment, there is provided an apparatus for data processing, including: at least one memory configured to store program code; and at least one processor configured to read the program code and operate as instructed by the program code, the program code including: generation code configured to cause the at least one processor to generate unique identification information associated with a user account, and transmit the unique identification information to the user account; acquisition code configured to cause the at least one processor to receive, from a server associated with an institution which verifies identity information corresponding to the user account, the unique identification information and a non-payment service request related to the user account; and service providing code configured to cause the at least one processor to identify the user account, and provide the user account with a non-payment service based on the non-payment service request.

According to an aspect of an example embodiment, there is provided a non-transitory computer-readable storage medium, storing instructions executable by at least one processor to perform: generating unique identification information associated with a user account; transmitting the unique identification information to the user account; receiving, from a server associated with an institution which verifies identity information corresponding to the user account, the unique identification information and a non-payment service request related to the user account; and identifying the user account based on the unique identification information, and providing the user account with a non-payment service based on the non-payment service request.

According to an aspect of an example embodiment of the disclosure provides an electronic device for data processing, including a memory, storing computer-readable instructions; and a processor, reading the computer-readable instructions stored in the memory to perform the method for data processing according to the foregoing embodiments.

According to an aspect of an example embodiment of the disclosure provides a computer program medium, storing computer-readable instructions, the computer-readable instructions, when executed by a processor of a computer, causing the computer to perform the method for data processing according to the foregoing embodiments.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 shows composition of a basic architectural structure according to an embodiment of the disclosure.

FIG. 2 shows a flowchart of a method for data processing according to an embodiment of the disclosure.

FIG. 3 shows a guide interface when a user registers a user account through an applet according to an embodiment of the disclosure.

FIG. 4 shows a registration interface when a user registers a user account through an applet according to an embodiment of the disclosure.

FIG. 5 shows a guide interface for acquiring an identity code after a user registers a user account through an applet according to an embodiment of the disclosure.

FIG. 6 shows an interface of a change details page of a payment institution after a user activates a user account and completes top-up according to an embodiment of the disclosure.

FIG. 7 shows an interface of a bill details page after a user activates a user account and completes top-up according to an embodiment of the disclosure.

FIG. 8 shows a flowchart of a user completing activation of a user account through an applet in an instant messaging client according to an embodiment of the disclosure.

FIG. 9 shows a flowchart of user account top-up by introducing a pre-order mechanism according to an embodiment of the disclosure.

FIG. 10 shows a flowchart of a user initiating exchange for balance in a user account according to an embodiment of the disclosure.

FIG. 11 shows a block diagram of an apparatus for data processing according to an embodiment of the disclosure.

FIG. 12 is a hardware diagram of an electronic device for data processing according to an embodiment of the disclosure.

### DETAILED DESCRIPTION

Exemplary implementations are now described more comprehensively with reference to the accompanying drawings. However, the exemplary implementations may be implemented in various forms and are not to be understood as being limited to the examples described herein. Conversely, the exemplary implementations are provided to make the description of the disclosure more comprehensive and complete, and comprehensively convey the idea of the exemplary implementations to a person skilled in the art. The accompanying drawings are merely exemplary illustrations of the disclosure and are not necessarily drawn to scale. The same reference numbers in the drawings represent the same or similar parts, and therefore, repeated descriptions thereof are omitted.

In addition, the described features, structures, or characteristics may be combined in one or more exemplary implementations in any appropriate manner. In the following description, many specific details are provided to give a full understanding of the exemplary implementations of the disclosure. However, a person skilled in the art is to be aware that, the technical solutions in the disclosure may be implemented without one or more of the particular details, or another method, unit, or step may be used. In other cases, well-known structures, methods, implementations, or operations are not shown or described in detail, to avoid obscuring the aspects of the disclosure.

Some of the block diagrams shown in the accompanying drawings are functional entities and do not necessarily correspond to physically or logically independent entities. The functional entities may be implemented in the form of software, or implemented in one or more hardware modules or integrated circuits, or implemented in different networks and/or processor apparatuses and/or micro-controller apparatuses.

The following briefly describes some concepts involved in the embodiments of the disclosure.

A financial institution refers to an institution in a financial system mainly engaged in a financial industry, for example: a banking institution, a securities institution, and an insurance institution.

A payment institution refers to a non-financial institution legally permitted to handle online payment services, for example, Internet payment, mobile phone payment, fixed phone payment, and digital television payment, for example: Tenpay, and WeChat wallet.

A user account refers to an account generated by a payment institution, to provide users with related services of the payment institution, for example: a Tenpay account, and a WeChat wallet account.

Unique identification information refers to information used for identification that is unique in a specific period of time, for example: a unique character string used for identification within a natural day including a current time point, and a unique two-dimensional code used for identification within a natural week including a current time point.

A non-payment service (or interchangeably referred to as an out-of-payment service) refers to a service other than a payment service provided by a payment institution, for example: a user account activation service provided by the payment institution, and a user account top-up service provided by the payment institution.

Real-name authentication refers to registering and taking effective measures to verify real identity information of a user, and taking continuous identification measures during existence of a business relationship with the user, to ensure effective verification of the user identity and true intention of the user.

A unit identification number (UIN) refers to a unique piece of identification information mainly used by a payment institution for identifying a user account.

An OpenID refers to a unique piece of identification information mainly used by an applet for identifying a user account.

The examples in the foregoing brief description related to some concepts are merely an exemplary description, and do not limit the function and scope of use of the embodiments of the disclosure.

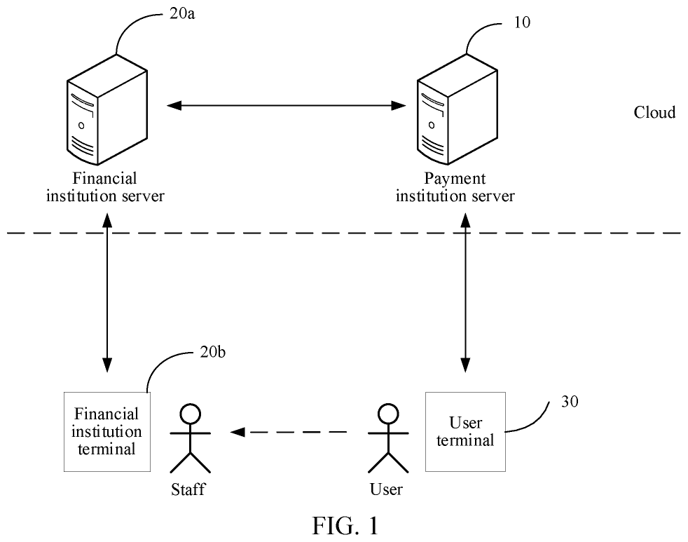

A basic architectural structure of an embodiment of the disclosure is described below with reference to FIG. 1.

FIG. 1 shows composition of a basic architectural structure of an embodiment of the disclosure, including a payment institution server 10, a financial institution server 20a, a financial institution terminal 20b, and a user terminal 30. The payment institution server 10 and the financial institution server 20a are located in the cloud. The financial institution terminal 20b refers to the front end of the financial institution server 20a (for example, a personal computer used by a bank staff for handling banking business), which is mainly exposed to the staff of the financial institution. The user terminal 30 refers to a terminal used by a user (for example, a mobile phone of the user).

In this embodiment, for a specific user, the payment institution server 10 in the payment institution generates unique identification information associated with a user account of the specific user, and the payment institution server 10 may identify and locate the user account of the specific user through the unique identification information. After receiving the unique identification information, the user may provide the unique identification information to the financial institution, and then request a non-payment service from the payment institution through the financial institution. For example, in the following application scenario, the user provides the unique identification information to the staff of the financial institution, and makes a non-payment service request to the staff of the financial institution. That is, the financial institution terminal 20b receives the unique identification information inputted by the bank staff, and the financial institution terminal 20b transmits the unique identification information and the non-payment service request through the financial institution server 20a to the payment institution server 10, so as to request a non-payment service from the payment institution through the financial institution.

The payment institution server 10 identifies the user account based on the unique identification information received from the financial institution; and then provides the user account with a corresponding non-payment service based on the non-payment service request received from the financial institution.

For example, a foreign tourist who takes a trip to the mainland of China wants to receive online fast payment services of a payment institution through an instant messaging client (for example, WeChat) for the sake of convenient consumption during the stay in the mainland of China. First, a user account is registered on a terminal (e.g., a mobile phone) used by the tourist. After the registration is completed, the payment institution server generates an 8-digit identity code associated with the user account, and transmits the identity code to the terminal (the mobile phone) of the tourist. The identity code is valid and unique within a day.

The tourist goes offline to a bank cooperating with the payment institution, provides the identity code to the staff of the bank, and explains to the staff the need for activating the user account associated with the identity code. According to relevant laws and regulations, the staff performs the real-name authentication on the tourist to verify identity information of the tourist.

After the real-name authentication is passed, the staff transmits the identity code and an account activation request to the payment institution server through a server of the bank by using a personal computer handling the banking business. After receiving the identity code, the payment institution server identifies the user account of the tourist; and then activates the user account of the tourist according to the account activation request, so that the user account of the tourist may be used normally.

In some embodiments, the payment institution server or the financial institution server may be an independent physical server, or may be a server cluster including a plurality of physical servers or a distributed system, or may be a cloud server providing basic cloud computing services, for example, a cloud service, a cloud database, cloud computing, a cloud function, cloud storage, a network service, cloud communication, a middleware service, a domain name service, a security service, a content delivery network (CDN), big data, and an artificial intelligence platform. The user terminal may be a smartphone, a tablet computer, a notebook computer, a desktop computer, a smart speaker, a smartwatch, or the like, but is not limited thereto. The user terminal and the server may be directly or indirectly connected in a wired or wireless communication manner, which is not limited in this embodiment of the disclosure.

This embodiment is merely an exemplary description, and does not limit the function and scope of use of the embodiments of the disclosure.

An example implementation process of this embodiment of the disclosure is described below. For the purpose of concise description, it is to be understood that, in the following description, a “payment institution” may refer to a “payment institution server”, a “financial institution” may refer to a combination of a “financial institution server” and a “financial institution terminal”, and a “user” may refer to a “user terminal”.

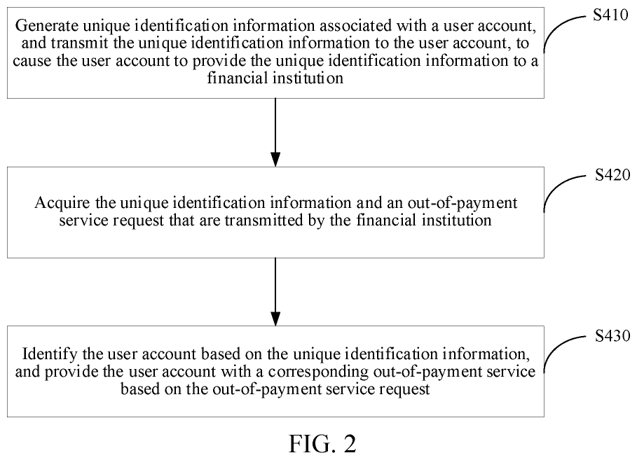

FIG. 2 shows a flowchart of a method for data processing according to an embodiment of the disclosure. This embodiment of the disclosure is performed by a computer device, and the computer device may be a payment institution server. As shown in FIG. 2, a method for data processing is provided, including:

Operation S410: Generate unique identification information associated with a user account, and transmit the unique identification information to the user account, to enable the user account to provide the unique identification information to a financial institution.

Operation S420: Acquire the unique identification information and a non-payment service request that are transmitted by the financial institution.

Operation S430: Identify the user account based on the unique identification information, and provide the user account with a corresponding non-payment service based on the non-payment service request.

In this embodiment of the disclosure, the payment institution (or the payment instruction server) may indirectly receive the non-payment service request of the user account through the financial institution, and then provides the user account with the corresponding non-payment service. Specifically, the payment institution (the payment instruction server) may indirectly receive the non-payment service request of the user account directly according to the relevant information transmitted by the financial institution, and then provides the user account with the non-payment service. In this method, every time a non-payment service is provided, the payment institution server may obtain real-time guarantee from the financial institution for the non-payment service. Accordingly, it is unnecessary to expose to the payment institution whether the user has applied for a bank card of a bank. Therefore, even if a user has not applied for a bank card, the user may still conveniently use the non-payment service provided by the payment institution, and then conveniently use the payment service provided by the payment institution. Particularly, when the user is a foreigner (e.g., a tourist) who travels to a certain country for a short time and it is inconvenient to apply for a bank card in that country, this embodiment of the disclosure may significantly bring more convenience for the user to receive the payment service and the non-payment service provided by the payment institution.

An example implementation process of this embodiment of the disclosure is described in detail below.

The following specifically uses an example in which foreigners use Chinese payment services after coming to China for detailed description. However, according to the following understanding, the solution of the disclosure is also applicable to a case under which other countries provide payment services to overseas users.

In operation S410, unique identification information associated with a user account is generated, and the unique identification information is transmitted to the user account, to enable the user account to provide the unique identification information to a financial institution.

In this embodiment of the disclosure, after a user account is registered, the payment institution generates unique identification information associated with the user account, and transmits the unique identification information to the user account. Therefore, when the user account needs to receive a non-payment service of a payment institution, the user account provides the unique identification information to the financial institution, and then requests the non-payment service from the payment institution through the financial institution.

For example: after a foreign tourist in the mainland of China registers a user account on a mobile phone, the payment institution generates unique identification information associated with the user account, and transmits the unique identification information to the mobile phone of the tourist. When the tourist wants to activate the user account, the tourist may go offline to a bank cooperating with the payment institution and provide the unique identification information to the bank. Further, after the tourist passes a series of authentication of the bank (for example: real-name authentication), the bank may transmit the unique identification information to the payment institution, and request the payment institution to activate the user account associated with the unique identification information.

The foregoing embodiment is merely an exemplary description, and does not limit the function and scope of use of the embodiments of the disclosure.

In some embodiments, the unique identification information includes, for example but not limited to: a unique identity code including a character string, and a unique two-dimensional code including a geometric figure.

In this embodiment of the disclosure, the unique identification information generated by the payment institution may be a unique identity code including a character string, or a unique two-dimensional code including a geometric figure.

For example: after a foreign tourist in the mainland of China registers a user account on a mobile phone, the payment institution generates a unique 8-digit identity code associated with the user account, and transmits the unique identification information to the mobile phone of the tourist. Therefore, after the tourist goes offline to a bank, the tourist may verbally inform the staff of the bank about the identity code. Further, the bank may transmit the identity code to the payment institution, and request the payment institution to activate the user account associated with the identity code.

In another example: after a foreign tourist in the mainland of China registers a user account on a mobile phone, the payment institution generates a unique two-dimensional code including a geometric figure and associated with the user account, and transmits the two-dimensional code to the mobile phone of the tourist. Therefore, after the tourist goes offline to a bank, the staff of the bank may collect the two-dimensional code by using a scanning terminal. Further, the bank may transmit the two-dimensional code to the payment institution, and request the payment institution to activate the user account associated with the two-dimensional code.

The foregoing embodiment is merely an exemplary description, and does not limit the function and scope of use of the embodiments of the disclosure.

In some embodiments, an update time point is preset, and the unique identification information is updated every time the update time point is reached.

In this embodiment of the disclosure, the unique identification information may updated dynamically. Specifically, the payment institution may preset an update time point, and update the unique identification information associated with the user account every time the update time point is reached. For example, the update time point preset by the payment institution is 00:00 every day. On Nov. 20, 2019, a foreign tourist registered a user account, and the payment institution generated an identity code “01234567” associated with the user account on that day, and “01234567” was unique on Nov. 20, 2019. At 00:00 on Nov. 21, 2019, the payment institution updated the identity code associated with the user account to “22222222”, and “22222222” is unique on Nov. 21, 2019. The update time point may be various determined according to an embodiment.

The advantage of the above solution in this embodiment of the disclosure is that, by dynamically updating the unique identification information, the possibility of leakage of the unique identification information is reduced, and the security of the user account is improved.

The foregoing embodiment is merely an exemplary description, and does not limit the function and scope of use of the embodiments of the disclosure.

In operation S420, the unique identification information and a non-payment service request that are transmitted by the financial institution are acquired.

In this embodiment of the disclosure, after the user account provides the unique identification information to the financial institution, if the financial institution determines that the user account meets the conditions for receiving the relevant services of the payment institution according to the relevant laws and regulations (for example: when the user of the user account passes the real-name authentication of the financial institution), the financial institution transmits the unique identification information provided by the user account to the payment institution, and transmits the non-payment service request of the user to the payment institution.

For example: after registering a user account, a foreign tourist provides the bank with the unique identity code associated with the user account and generated by the payment institution offline, and informs the bank that the tourist needs to activate the user account associated with the identity code. The bank carries out real-name authentication of the tourist in accordance with relevant laws and regulations. After the tourist passes the real-name authentication, the bank transmits the identity code to the payment institution, and transmits the account activation request to the payment institution.

In operation S430, the user account is identified based on the unique identification information, and the user account is provided with a corresponding non-payment service based on the non-payment service request.

In this embodiment of the disclosure, after obtaining the unique identification information and the non-payment service request from the financial institution, the payment institution identifies the user account associated with the unique identification information based on the unique identification information, and then provides the user account with the corresponding non-payment service based on the non-payment service request.

For example, after obtaining an identity code and an account activation request from the bank, the payment institution may determine that the user account associated with the identity code has passed a series of authentication from the bank, and may receive relevant services provided by the payment institution according to relevant laws and regulations. Then the payment institution identifies the corresponding user account according to the identity code, and then activates the user account.

The specific process of this embodiment of the disclosure in cases of different types of non-payment service requests is described in detail below.

First, the specific process of this embodiment of the disclosure in the case that the non-payment service request is an account activation request is described in detail.

In some embodiments, the user account is not activated, and the non-payment service request includes an account activation request. The providing the user account with a corresponding non-payment service based on the non-payment service request includes: providing the user account with a corresponding account activation service based on the account activation request.

In this embodiment of the disclosure, when the user account provides the associated unique identification information to the financial institution, the user account has not yet been activated, and the top-up and payment cannot be completed. In this case, the user account transmits an account activation request to the payment institution through the financial institution to request activation of the user account.

After obtaining the unique identification information and the account activation request from the financial institution, the payment institution may determine that the user account associated with the unique identification information has passed a series of authentication of the financial institution, and may receive relevant services provided by the payment institution according to relevant laws and regulations. Then the payment institution identifies the corresponding user account according to the unique identification information, and then activates the user account.

In some embodiments, the method for data processing provided by this embodiment of the disclosure further includes the following technical solution: acquiring a user security level configured by the financial institution for the user account based on identity information corresponding to the user account; and configuring an account permission matching the user security level for the user account.

In this embodiment of the disclosure, after receiving the account activation request, and in addition to activating the user account, the payment institution further configures the corresponding account permission for the user account, to limit the scope and type of services that the user account may receive.

Specifically, after completing a series of authentication for the user account, the financial institution further configures the corresponding user security level for the user account based on the identity information corresponding to the user account, to identify the credibility of the user account. The financial institution transmits the configured user security level to the payment institution, so that the payment institution configures an account permission matching the user security level for the user account according to the user security level, to limit the scope and type of services that the user account may receive.

For example, a set of user security level standards are preset. In the user security level standards, user security levels range from level 1 to level 3. A higher level indicates higher credibility of the corresponding user account.

If the user security level obtained by the payment institution from the financial institution is 1, an online transfer function will not be enabled while configuring a limit of 100 RMB for the corresponding user account. If the user security level obtained by the payment institution from the financial institution is 2, an online transfer function will not be enabled while configuring a limit of 500 RMB for the corresponding user account. If the user security level obtained by the payment institution from the financial institution is 3, an online transfer function will be enabled while configuring a limit of 1000 RMB for the corresponding user account.

The advantage of the above solution in this embodiment of the disclosure is that, the user security level is configured by the financial institution, and then the payment institution configures the account permission on this basis, so that the payment institution may have some degree of control over potential risks when providing the user account with services.

The foregoing embodiment is an exemplary description, and does not limit the function and scope of use of the embodiments of the disclosure.

The specific process of this embodiment of the disclosure in the case that the non-payment service request is an account top-up request is described in detail below.

In some embodiments, the user account is activated, and the non-payment service request includes an account top-up request. The providing the user account with a corresponding non-payment service based on the non-payment service request includes: providing the user account with a corresponding account top-up service based on the account top-up request.

In this embodiment of the disclosure, when the user account provides the associated unique identification information to the financial institution, the user account has been activated, and the top-up and payment may be performed. In this case, the user account transmits an account top-up request to the payment institution through the financial institution to request top-up to the user account (the user account does not require the intervention of the financial institution in the process of payment).

After obtaining the unique identification information and the account top-up request from the financial institution, the payment institution may determine that the user account associated with the unique identification information has passed a series of authentication of the financial institution, and may receive relevant services provided by the payment institution according to relevant laws and regulations. Then the payment institution identifies the corresponding user account based on the unique identification information, and then top up the user account based on a specific top-up amount described in the account top-up request.

For example: after registering and activating a user account, a foreign tourist provides the bank with the unique identity code associated with the user account and generated by the payment institution offline, and informs the bank that the tourist needs to top up 500 RMB to the user account associated with the identity code. The bank carries out real-name authentication of the tourist in accordance with relevant laws and regulations. After the tourist passes the real-name authentication, and the bank charges the tourist 500 RMB or the equivalent foreign currency, the bank transmits the identity code to the payment institution, and transmits the account a top-up request to the payment institution.

After receiving the identity code and the account top-up request from the bank, the payment institution may identify the user account of the tourist based on the identity code; and then, top up 500 RMB to the user account of the tourist based on the account top-up request.

This embodiment is merely an exemplary description, and does not limit the function and scope of use of the embodiments of the disclosure.

In some embodiments, the user account is configured with a corresponding account permission. The foregoing operation of providing the user account with a corresponding account top-up service based on the account top-up request may be implemented through the following technical solution: verifying validity of the account top-up request based on the account permission; and providing the user account with the corresponding account top-up service in a case that the account top-up request is valid.

In this embodiment of the disclosure, the payment institution is further configured with a corresponding account permission for the activated user account, to limit the scope and type of services that the user account may receive.

After obtaining the unique identification information and the account top-up request from the financial institution, and after identifying the corresponding user account based on the unique identification information, the payment institution does not directly top up the user account based on the specific top-up amount described in the account top-up request. Instead, after verifying the validity of the account top-up request based on the account permission of the user account, the payment institution determines whether to top up the user account according to whether the account top-up request is valid.

The payment institution tops up the user account based on determination that the account top-up request is valid. The payment institution refuses to top up the user account based on determination that the account top-up request is invalid.

For example: after a foreign tourist registers and activates a user account, the payment institution configures a quota of 1000 RMB for the user account of the tourist. The tourist provides the bank with the unique identity code associated with the user account and generated by the payment institution offline, and informs the bank that the tourist needs to top up 500 RMB to the user account associated with the identity code. After a series of operations, the bank transmits the identity code and the account top-up request to the payment institution.

After receiving the identity code and the account top-up request from the bank, the payment institution may identify the user account of the tourist based on the identity code; and then, determine, according to the current remaining amount in the user account and the quota configured for the user account when the user account is activated, the current remaining quota of the user account. If the current remaining quota is greater than 500 RMB, the payment institution determines that the account top-up request is valid, and then tops up 500 RMB to the user account. If the current remaining quota is less than 500 RMB, the payment institution determines that the account top-up request is invalid, and refuses to top up the user account.

The advantage of the solution of this embodiment of the disclosure is that, the validity of the account top-up request is verified based on the account permission, which improves the security of the account top-up process.

This embodiment is merely an exemplary description, and does not limit the function and scope of use of the embodiments of the disclosure.

In some embodiments, the foregoing process of providing the user account with a corresponding account top-up service may be implemented through the following technical solution: generating a corresponding top-up order based on the account top-up request, and transmitting the top-up order to the financial institution; acquiring response information of the financial institution to the top-up order; and providing the user account with the corresponding account top-up service based on the response information.

In this embodiment of the disclosure, a pre-order mechanism is adopted for top-up. Specifically, after determining that the account top-up request is valid, the payment institution does not directly top up the user account. Instead, the payment institution generates the corresponding top-up order first based on the account top-up request, and transmits the top-up order to the financial institution, so that the financial institution may guide the user to provide funds to be topped up to the financial institution based on the top-up order. That is, the financial institution collects the funds on behalf of the payment institution.

After the financial institution receives the funds, the top-up order is completed. Then the financial institution returns top-up order completion information to the payment institution as the response information to the top-up order. Therefore, the payment institution may determine that the financial institution has received the funds for the top-up, and then the payment institution tops up the funds to the user account.

For example: after registering and activating a user account, a foreign tourist provides the bank with the unique identity code associated with the user account and generated by the payment institution offline, and informs the bank that the tourist needs to top up 500 RMB to the user account associated with the identity code. The bank carries out real-name authentication of the tourist in accordance with relevant laws and regulations. After the tourist passes the real-name authentication, the bank does not immediately charge the tourist 500 RMB, but first transmits the identity code to the payment institution, and transmits the account top-up request to the payment institution.

Then the payment institution determines the validity of the account top-up request. If the payment institution determines that the account top-up request is valid, the payment institution generates the corresponding top-up order based on the account top-up request, and transmits the top-up order to the bank to instruct the bank to charge the tourist 500 RMB.

After receiving the top-up order, the bank charges the tourist 500 RMB. After the charging is successful, the bank returns a notification of the completion of the top-up order to the payment institution. After receiving the notification of the completion of the top-up order, the payment institution tops up 500 RMB to the user account of the tourist.

The advantage of the solution in this embodiment of the disclosure is that, by introducing the pre-order mechanism, the payment institution tops up the user account only after determining that the financial institution has indeed completed the top-up on behalf of the payment institution, avoiding the risk of money shortage of a transaction for network reasons.

The foregoing embodiment is merely an exemplary description, and does not limit the function and scope of use of the embodiments of the disclosure.

In the foregoing description about this embodiment of the disclosure, the payment institution may not acquire the user identity information corresponding to the user account, and the financial institution may be solely responsible for the processing of the user identity information corresponding to the user account (for example: the real-name authentication on the user account performed based on the user identity information corresponding to the user account). In this case, the payment institution will receive the unique identification information and the non-payment service request that are transmitted by the financial institution only after the processing of the user identity information by the financial institution is passed (for example, after the real-name authentication is passed). It is to be understood that, in addition to the financial institution processing the user identity information corresponding to the user account, if the payment institution also processes the user identity information corresponding to the user account, the security of user account management will be further enhanced.

An example implementation process of this embodiment of the disclosure in the case that the payment institution also processes the user identity information corresponding to the user account is described in detail below.

In some embodiments, before the providing the user account with a corresponding non-payment service based on the non-payment service request, the following technical solution may be further performed: acquiring the user identity information corresponding to the user account transmitted by the financial institution; and the providing the user account with a corresponding non-payment service based on the non-payment service request includes: providing the user account with the corresponding non-payment service based on the user identity information and the non-payment service request.

In this embodiment of the disclosure, the payment institution may further acquire the user identity information corresponding to the user account transmitted by the financial institution, and then provide the user account with the corresponding non-payment service based on the user identity information and the non-payment service request.

An example of a process of an embodiment in which the payment institution also processes the identity information corresponding to the user account in cases of different types of non-payment service requests is described in detail below.

First, a process of an embodiment in which the payment institution also processes the identity information corresponding to the user account in the case that the non-payment service request is an account activation request is described in detail.

In some embodiments, the user account is not activated, and the non-payment service request includes an account activation request. The foregoing process of providing the user account with the corresponding non-payment service based on the user identity information and the non-payment service request may be implemented through the following technical solution: storing the user identity information, and associating the user identity information with the user account; and providing the user account with a corresponding account activation service based on the account activation request.

In this embodiment of the disclosure, when the user account provides the associated unique identification information to the financial institution, the user account has not been activated, and the top-up and payment cannot be completed. In this case, the user account transmits an account activation request to the payment institution through the financial institution to request activation of the user account.

In addition to obtaining the unique identification information and the account activation request from the financial institution, the payment institution further obtains the identity information corresponding to the user account. The payment institution identifies the corresponding user account according to the unique identification information, and then activates the user account. In addition, the payment institution stores the user identity information, and associates the user identity information with the user account, so as to further verify the user identity information of the user account on the basis of a series of authentication performed by the financial institution when subsequently providing the user account with services.

The advantage of the solution in this embodiment of the disclosure is that, when activating the user account, the payment institution stores the corresponding user identity information and associates the user identity information with the user account, so that the user identity information of the user account may be further verified in a subsequent process, which improves the security of user account management.

In some embodiments, the following technical solution may be further performed: configuring a corresponding user security level for the user account based on the user identity information; and configuring an account permission matching the user security level for the user account.

In this embodiment of the disclosure, after obtaining the user identity information from the financial institution, the payment institution personally configures the corresponding user security level for the user account, and then configures the account permission matching the user security level for the user account.

The payment institution may preset a score corresponding to each branch information (or sub-identity information) that the user identity information may include, then add up the score corresponding to each branch information actually included in the obtained user identity information to obtain a total score of the obtained user identity information, and then configure the user security level according to the total score.

For example: the payment institution presets a score for the information that has to be included in the user identity information as follows: 20 points for name information; 20 points for face information; 10 points for nationality information; and 10 points for phone information; and the payment institution presets a score for the information that is optionally included in the user identity information as follows: 15 points for current address information; 15 points for educational information; and 10 points for employment information.

In an example embodiment, if the total score of each branch information included in the obtained user identity information is not greater than 60 points, the user security level configured for the user account is 1. If the score is greater than 60 points but not greater than 90 points, the user security level configured for the user account is 2. If the score is equal to 100 points, the user security level configured for the user account is 3.

The foregoing embodiment is merely an exemplary description, and does not limit the function and scope of use of the embodiments of the disclosure.

In some embodiments, a corresponding institution security level is pre-configured for the financial institution. The configuring a corresponding user security level for the user account based on the identity information includes: configuring the corresponding user security level for the user account based on the institution security level and the identity information.

In this embodiment of the disclosure, the payment institution may cooperate with a plurality of financial institutions, and configure a corresponding institution security level for each financial institution. The institution security level describes the credibility of the corresponding financial institution.

After obtaining the user identity information from the financial institution, the payment institution combines the user identity information with the institution security level, and configures the corresponding user security level for the user account.

The institution security level configured by the payment institution for the financial institution may be controlled between 0 and 1, for example. In addition, the payment institution may preset a score corresponding to each branch (or sub-identity) information that the user identity information may include, and then add up the score corresponding to each branch information actually included in the obtained user identity information to obtain a total score of the obtained user identity information. Therefore, the payment institution may use the institution security level as the weight of the total score, and multiply the institution security level by the total score to obtain a weighted score, and then configure the user security level according to the weighted score.

For example, the payment institution pre-configures an institution security level of 1 for a bank A, an institution security level of 0.8 for a bank B, and an institution security level of 0.6 for a securities institution C. If the weighted score of the obtained user identity information is not greater than 60 points, the user security level configured for the user account is 1. If the score is greater than 60 points but not greater than 90 points, the user security level configured for the user account is 2. If the score is equal to 100 points, the user security level configured for the user account is 3.

If the total score of the user identity information obtained by the payment institution from the bank A is 100 points, the weighted score is (100*1)=100 points, and the user security level configured for the corresponding user account is 3. If the total score of the user identity information obtained by the payment institution from the bank B is 100 points, the weighted score is (100*0.8)=80 points, and the user security level configured for the corresponding user account is 2. If the total score of the user identity information obtained by the payment institution from the securities institution C is 100 points, the weighted score is (100*0.6)=60 points, and the user security level configured for the corresponding user account is 1.

The advantage of the solution in this embodiment of the disclosure is that, the payment institution configures the user security level in combination with the institution security level, so that the account permission may be configured more accurately.

This embodiment is merely an exemplary description, and does not limit the function and scope of use of the embodiments of the disclosure.

An example process of an embodiment in which the payment institution also processes the identity information corresponding to the user account in the case that the non-payment service request is an account top-up request is described in detail below.

In some embodiments, the user account is activated, and the non-payment service request includes an account top-up request. The providing the user account with a corresponding non-payment service based on the user identity information and the non-payment service request includes: providing the user account with a corresponding account top-up service based on the user identity information and the account top-up request.

In this embodiment of the disclosure, when the user account provides the associated unique identification information to the financial institution, the user account has been activated, and the top-up and payment may be performed. In this case, the user account transmits an account top-up request to the payment institution through the financial institution to request top-up to the user account.

After obtaining the unique identification information, the account top-up request, and the user identity information transmitted by the financial institution from the financial institution, the payment institution identifies the corresponding user account based on the unique identification information, and then tops up the user account based on the user identity information and the account top-up request.

In some embodiments, the user account is configured with a corresponding account permission. The foregoing process of providing the user account with a corresponding account top-up service based on the user identity information and the account top-up request may be implemented through the following technical solution: verifying the user identity information based on information that the user account has been associated with; verifying validity of the account top-up request based on the account permission; and providing the user account with the corresponding account top-up service in a case that the user identity information is verified and the account top-up request is valid.

In this embodiment of the disclosure, before providing the user account with the corresponding account top-up service, the payment institution verifies the user identity information received from the financial institution according to the user account and the associated information; and verifies the validity of the account top-up request based on the pre-configured account permission. In a case that the verification of the user identity information is passed and the account top-up request is valid, the payment institution provides the user account with the corresponding account top-up service.

For example: when activating a user account of a foreign tourist, the payment institution stores identity information of the tourist, and associates the identity information of the tourist with the user account; and configures a corresponding account permission for the user account.

After the user account is activated, the tourist provides the bank with a unique identity code associated with the user account and generated by the payment institution offline, and informs the bank that the tourist needs to top up 500 RMB to the user account associated with the identity code. The bank carries out real-name authentication of the tourist in accordance with relevant laws and regulations. After the real-name authentication of the bank is passed, the bank transmits the identity code of the tourist, the account top-up request, and the identity information about the real-name authentication just performed to the payment institution.

After receiving the identity code, the account top-up request and the identity information about the real-name authentication performed by the financial institution from the bank, the payment institution identifies the user account of the tourist based on the identity code; then compares the stored identity information associated with the user account with the identity information about the real-name authentication performed by the financial institution to verify whether the two are consistent; and verifies validity of the account top-up request based on the account permission. If the two are consistent and the account top-up request is valid, the payment institution tops up 500 RMB to the user account.

The advantage of the solution of this embodiment of the disclosure is that, the payment institution provides the account top-up service after both the verification of the user identity information and the verification of the validity of the account top-up request are passed, which improves the security of account top-up.

This embodiment is merely an exemplary description, and does not limit the function and scope of use of the disclosure.

In some embodiments, the foregoing process of providing the user account with a corresponding account top-up service may be implemented through the following technical solution: generating a corresponding top-up order based on the account top-up request, and transmitting the top-up order to the financial institution; acquiring response information of the financial institution to the top-up order; and providing the user account with the corresponding account top-up service based on the response information.

In this embodiment of the disclosure, a pre-order mechanism is adopted for top-up. It is to be understood that, an example implementation process of this embodiment may be the same as the foregoing example implementation process of the pre-order embodiment in which the payment institution does not process the user identity information corresponding to the user account. Therefore, details are not repeated herein again.

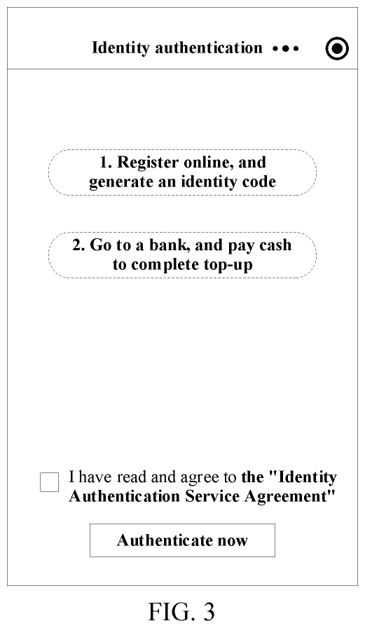

Referring to FIG. 3 to FIG. 7, a terminal interface of this embodiment of the disclosure when the user receives the non-payment service provided by the payment institution is exemplarily shown below.

FIG. 3 shows a guide interface when a user attempts to register an account through an applet according to an embodiment of the disclosure. In this embodiment, the user opens an applet of a client in a mobile phone to register an account. In the guide interface, guide information shown in FIG. 3 is displayed to guide the user to register the account, and then an identity code is acquired. Then, the user is instructed to go to a bank to pay cash to complete the top-up.

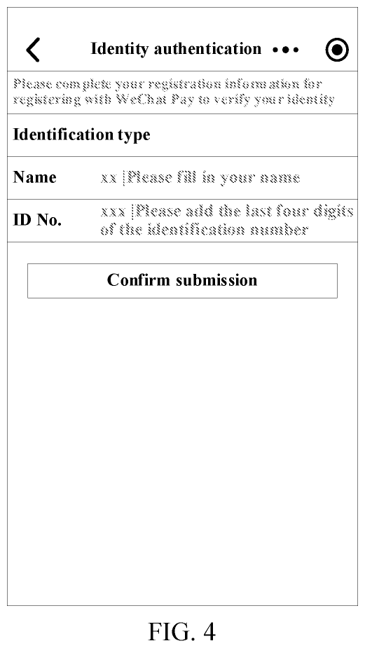

FIG. 4 shows a registration interface when a user registers a user account through an applet according to an embodiment of the disclosure. In this embodiment of the disclosure, according to the content displayed on the registration interface, the user correspondingly supplements various registration information including identification types, names, and identification numbers. After the supplement is completed, the user clicks a “confirm submission” key to complete the submission of the registration information.

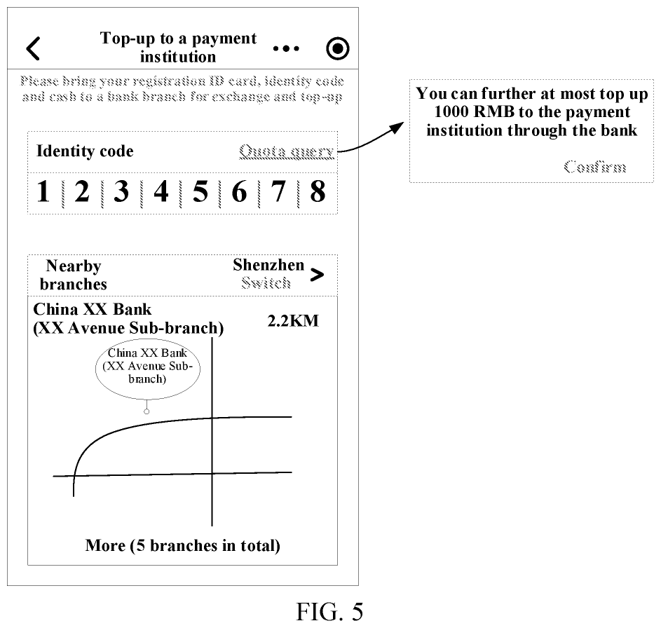

FIG. 5 shows a guide interface for acquiring an identity code after a user registers a user account through an applet according to an embodiment of the disclosure. In this embodiment, the user submits the registration information, and after the registration is completed, a unique 8-digit identity code is received on the guide interface in the applet. Moreover, the guide interface further shows in a map bank branches where the user may go for top-up, to guide the user to go to the bank branches shown in the map for top-up.

In the guide interface, if the user clicks a “quota query” key, the guide interface may further display quota information shown on the right, to inform the user of the quota that the user may top up to the user account through the bank.

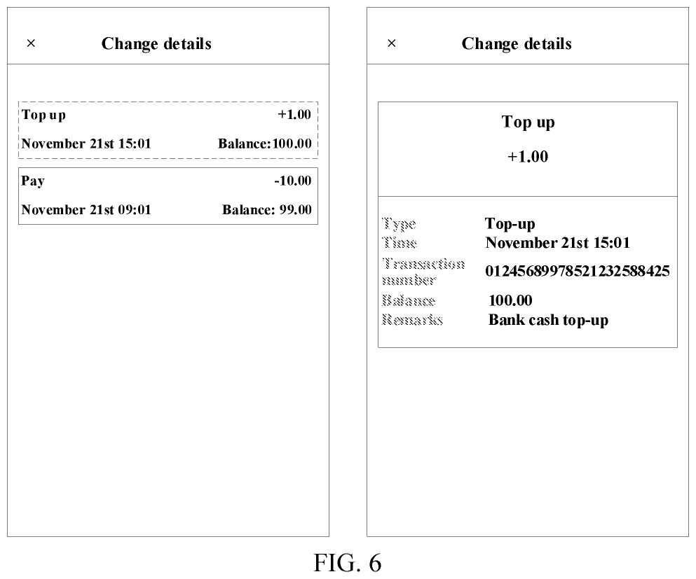

FIG. 6 shows an interface of a change details page in a user account after a user activates a user account and completes top-up according to an embodiment of the disclosure. In this embodiment, after going to a bank to activate a user account and topping up 1 RMB, the user clicks to enter the change details of the user account of the user, and a list of change top-up and change payment is displayed first. After clicking a dashed line part shown on the left side in FIG. 6, a detailed interface of the change top-up shown on the right side is entered, including a type, time, a transaction number, balance, and a note.

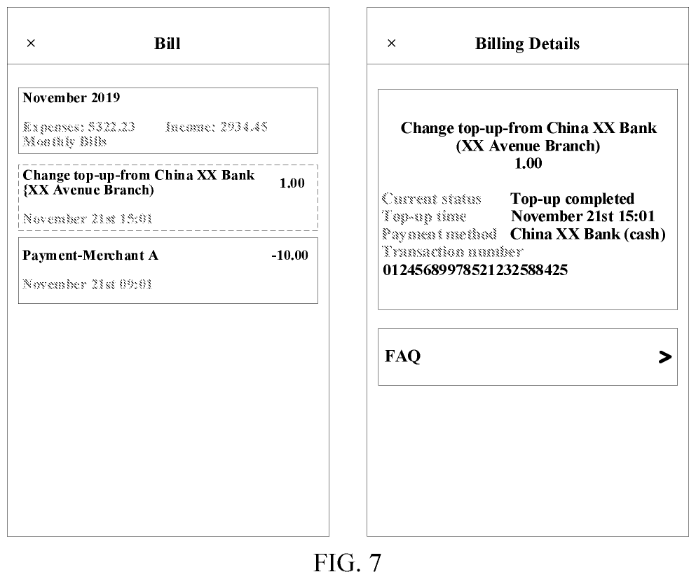

FIG. 7 shows an interface of a bill details page in a user account after a user activates a user account and completes top-up according to an embodiment of the disclosure. In this embodiment, after going to a bank to activate a user account and topping up 1 RMB, the user clicks to enter the bill details of the user account of the user, and a bill list of the current month is displayed first. After clicking a dashed line part shown on the left side in FIG. 7, a detailed interface of the bill details shown on the right side is entered, including a current status, top-up time, a payment method, and a transaction number.

The embodiments corresponding to FIG. 3 to FIG. 7 are merely exemplary descriptions, and do not limit the function and scope of use of the embodiments of the disclosure.

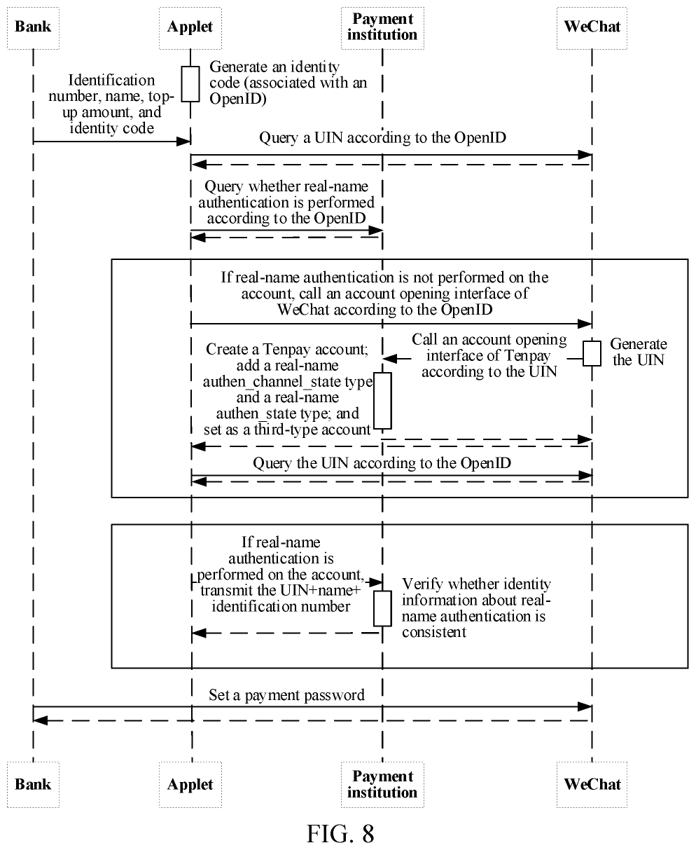

FIG. 8 shows a flowchart of a user completing activation of a user account through an applet in an instant messaging client (for example, WeChat) according to an embodiment of the disclosure. An OpenID refers to a unique piece of identification information mainly used by an applet for identifying a user account. A UIN refers to a unique piece of identification information mainly used by a payment institution for identifying a user account. The identity code, the corresponding OpenID, and the corresponding UIN are mapped to and associated with each other. A user account that is not activated is temporarily perceived by only an applet and not perceived by a payment institution. In this case, a UIN corresponding to the user account does not exist in WeChat, and the corresponding user account does not exist in the payment institution. Because the user completes the activation of the user account in a bank, for the purpose of concise presentation, the “user” and the “bank” are combined and displayed as the “bank” in FIG. 8.

In this embodiment of the disclosure, after the user completes registration of a user account in an applet, the applet generates, according to an OpenID generated during the registration, an identity code associated with the OpenID. The user provides the identity code to the bank, and after the real-name authentication is completed, the bank transmits an identification number, a name, top-up amount, and the identity code to the applet. The applet finds a corresponding OpenID according to the identity code, and then queries WeChat for a UIN corresponding to the account according to the OpenID; and checks with the payment institution whether real-name authentication is performed on the account according to the OpenID after obtaining feedback from WeChat.

If WeChat feeds back that the UIN corresponding to the account does not exist, and/or the payment institution feeds back that real-name authentication is not performed on the account, the applet calls an account opening interface of WeChat according to the OpenID to activate the account. WeChat generates the corresponding UIN, and then calls an account opening interface of the payment institution according to the UIN. The payment institution creates a user account and adds two parameters: a real-name authen_channel_state type and a real-name authen_state type. If it is confirmed that the real-name authentication of the user account is passed through a specific authentication channel according to the two parameters, the user account is set as a third-type account, thereby activating the user account. The real-name authen_channel_state type mainly describes an authentication channel of real-name authentication (for example, whether the authentication is performed by a banking institution or a securities institution). The real-name authen_state type mainly describes whether the real-name authentication is passed.

If WeChat feeds back the corresponding UIN, and the payment institution feeds back that real-name authentication is performed on the account, the applet transmits the UIN, the name, and the identification number to the payment institution. The payment institution verifies whether the received identity information is consistent with the identity information with which the corresponding user account has been associated according to the received UIN, name, and identification number, and then returns a result to the applet to activate the user account.

After the activation is completed, the user may set a payment password in WeChat to complete the setting of the user account.

The foregoing embodiment is merely an exemplary description, and does not limit the function and scope of use of the disclosure.

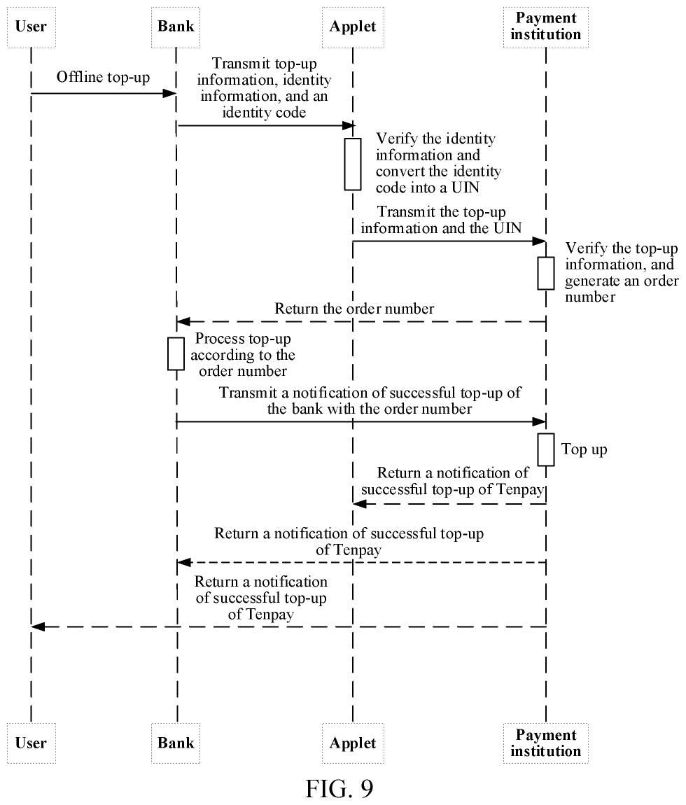

FIG. 9 shows a flowchart of user account top-up by introducing a pre-order mechanism according to an embodiment of the disclosure.

In this embodiment of the disclosure, the user goes to a bank, provides identity information and an identity code to the bank, and performs offline top-up. The bank transmits corresponding top-up information, and the received identity information and identity code to an applet. After verifying the identity information, the applet converts the identity code into a UIN, and then transmits the top-up information and the UIN to the payment institution.

The payment institution identifies the user account according to the UIN; then verifies the top-up information; and generates an order number after the verification is passed, and then returns the order number to the bank.

The bank processes the top-up and charges the user funds for the top-up according to the received order number. After the top-up is successful, the bank transmits a notification of successful top-up of the bank to the payment institution with the order number.

After receiving the notification of successful top-up of the bank, the payment institution tops up the user account of the user, returns a notification of successful top-up of the payment institution to the applet, returns the notification of successful top-up of the payment institution to the bank, and returns the notification of successful top-up of the payment institution to the user.

The foregoing embodiment is merely an exemplary description, and does not limit the function and scope of use of the disclosure.

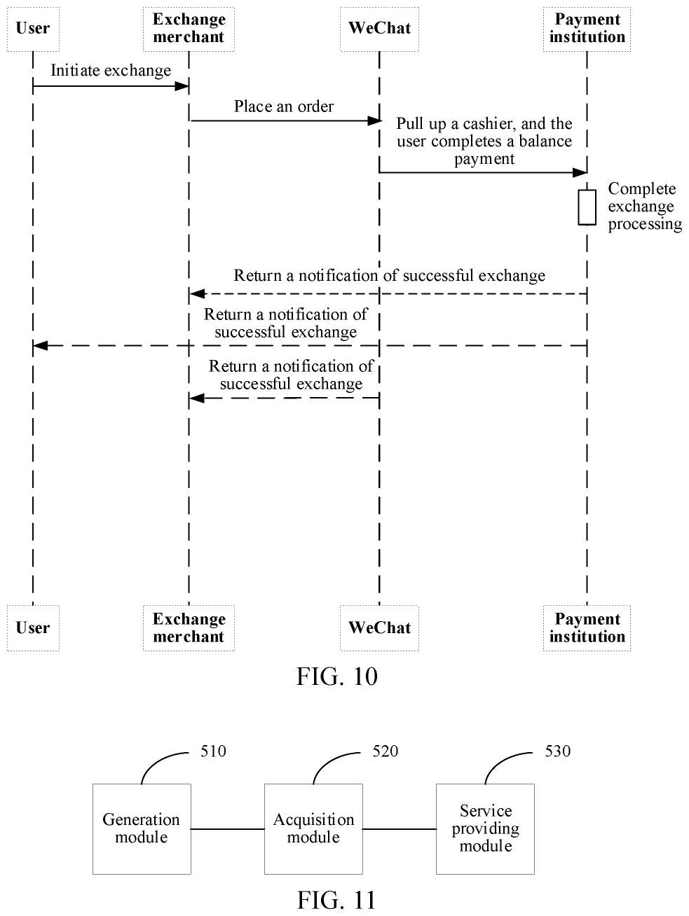

FIG. 10 shows a flowchart of a user initiating exchange for balance in a user account according to an embodiment of the disclosure.

In this embodiment of the disclosure, the user needs to exchange balance in the user account. Specifically, the user initiates an exchange transaction to an exchange merchant. The exchange merchant then places an order on WeChat. WeChat pulls up a cashier for exchange transactions, so that the user may use the cashier to pay the balance in the user account to exchange the balance. After completing the processing of the exchange transaction, the payment institution returns a notification of successful exchange to the exchange merchant, and returns the notification of successful exchange to the user. WeChat also returns the notification of successful exchange to the exchange merchant. Therefore, the user may get cash from the exchange merchant after exchanging the balance in the user account.

The foregoing embodiment is merely an exemplary description, and does not limit the function and scope of use of the disclosure.

FIG. 11 shows a block diagram of an apparatus for data processing according to an embodiment of the disclosure. According to this embodiment of the disclosure, as shown in FIG. 11, an apparatus for data processing is further provided. The apparatus for data processing may be a computer program (including a program code) running in a computer device. For example, the apparatus for data processing provides an application. The apparatus may be used for performing the corresponding operations in the method provided by this embodiment of the disclosure. The apparatus includes: a generation module 510, configured to generate unique identification information associated with a user account, and transmit the unique identification information to the user account, to enable the user account to provide the unique identification information to a financial institution; an acquisition module 520, configured to acquire the unique identification information and a non-payment service request; and a service providing module 530, configured to identify the user account based on the unique identification information, and provide the user account with a corresponding non-payment service based on the non-payment service request.

In this embodiment of the disclosure, the user account is not activated, the non-payment service request includes an account activation request, and the apparatus is configured to: provide the user account with a corresponding account activation service based on the account activation request.

In this embodiment of the disclosure, the apparatus is configured to: acquire a user security level configured for the user account by the financial institution based on identity information corresponding to the user account; and configure an account permission matching the user security level for the user account.

In this embodiment of the disclosure, the user account is configured with a corresponding account permission; and the apparatus is configured to: verify validity of the account top-up request based on the account permission; and provide the user account with the corresponding account top-up service in a case that the account top-up request is valid.

In this embodiment of the disclosure, the apparatus is configured to: generate a corresponding top-up order based on the account top-up request, and transmit the top-up order to the financial institution; acquire response information of the financial institution to the top-up order; and provide the user account with the corresponding account top-up service based on the response information.

In this embodiment of the disclosure, the apparatus is configured to: acquire user identity information corresponding to the user account transmitted by the financial institution; and provide the user account with the corresponding non-payment service based on the user identity information and the non-payment service request.

In this embodiment of the disclosure, the user account is not activated, the non-payment service request includes an account activation request, and the apparatus is configured to: store the user identity information, and associate the user identity information with the user account; and provide the user account with a corresponding account activation service based on the account activation request.

In this embodiment of the disclosure, the apparatus is configured to: configure a corresponding user security level for the user account based on the user identity information; and configure an account permission matching the user security level for the user account.

In this embodiment of the disclosure, a corresponding institution security level is pre-configured for the financial institution; and the apparatus is configured to: configure a corresponding user security level for the user account based on the institution security level and the identity information.

In this embodiment of the disclosure, the user account is activated, the non-payment service request includes an account top-up request, and the apparatus is configured to: provide the user account with a corresponding account top-up service based on the user identity information and the account top-up request.

In this embodiment of the disclosure, the user account is configured with a corresponding account permission; and the apparatus is configured to: verify the user identity information based on information that the user account has been associated with; verify validity of the account top-up request based on the account permission; and provide the user account with the corresponding account top-up service in a case that the user identity information is verified and the account top-up request is valid.

In this embodiment of the disclosure, the apparatus is configured to: generate a corresponding top-up order based on the account top-up request, and transmit the top-up order to the financial institution; acquire response information of the financial institution to the top-up order; and provide the user account with the corresponding account top-up service based on the response information.

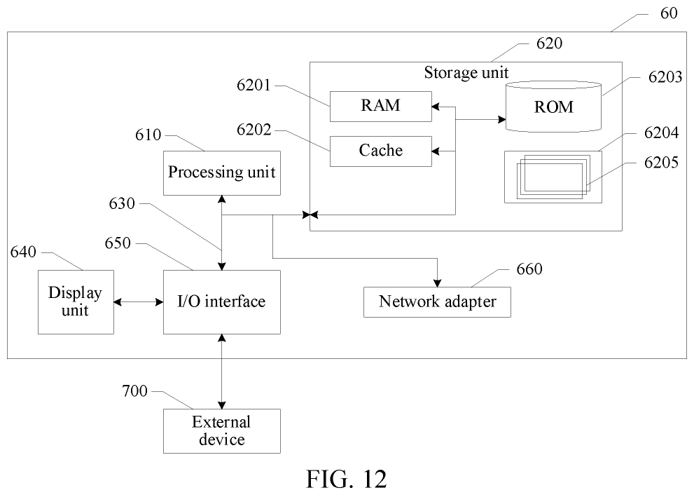

FIG. 12 is a hardware diagram of an electronic device for data processing according to an embodiment of the disclosure. An electronic device 60 for data processing according to this embodiment of the disclosure is described below with reference to FIG. 12. The electronic device 60 for data processing shown in FIG. 12 is merely an example, and does not limit the function and scope of use of this embodiment of the disclosure.

As shown in FIG. 12, the electronic device 60 for data processing is represented in the form of a general-purpose computing device. Components of the electronic device 60 for data processing may include, but are not limited to: at least one processing unit 610, at least one storage unit 620, and a bus 630 connecting different system components (including the storage unit 620 and the processing unit 610).

The storage unit stores a program code, and the program code may be executed by the processing unit 610, so that the processing unit 610 performs the operations according to various exemplary implementations of the disclosure described in the descriptions of the foregoing exemplary methods of the specification. For example, the processing unit 610 may perform each operation shown in FIG. 2.

The storage unit 620 may include a readable medium in the form of a volatile storage unit, for example, a random access memory (RAM) unit 6201 and/or a cache storage unit 6202, and may further include a read-only memory (ROM) unit 6203.

The storage unit 620 may further include a program/utility tool 6204 having a group of (at least one) program modules 6205. Such a program module 6205 includes, but is not limited to, an operating system, one or more application programs, other program modules, and program data. Each or a combination of these examples may include implementation of a network environment.

The bus 630 may indicate one or more of several types of bus structures, including a storage unit bus or storage unit controller, a peripheral bus, an accelerated graphics port, a processing unit, or a local bus using any of a plurality of bus structures.

The electronic device 60 for data processing may also communicate with one or more external devices 700 (for example, a keyboard, a pointing device, a Bluetooth device, or the like), and may also communicate with one or more devices that enable a user to interact with the electronic device 60 for data processing, and/or communicate with any device (for example, a router, a modem, or the like) that enables the electronic device 60 for data processing to communicate with one or more other computing devices. Such communication may be performed by using an input/output (I/O) interface 650. The I/O interface 650 is connected to a display unit 640. In addition, the electronic device 60 for data processing may further communicate with one or more networks, for example, a local area network (LAN), a wide area network (WAN), and/or a public network (for example, the Internet) through a network adapter 660. As shown in the figure, the network adapter 660 may communicate with other modules of the electronic device 60 for data processing through the bus 630. It is to be understood that although not shown in the figure, other hardware and/or software modules may be used in combination with the electronic device 60 for data processing, including, but not limited to microcode, a device controller, a redundancy processing unit, an external disk controller array, a RAID system, a tape controller, a data backup storage system, or the like.

According to the foregoing descriptions of the implementations, a person skilled in the art may readily understand that the exemplary implementations described herein may be implemented by using software, or may be implemented by combining software and necessary hardware. Therefore, the technical solutions of the implementations of the disclosure may be implemented in a form of a software product. The software product may be stored in a non-volatile computer-readable storage medium (which may be a compact disc read-only memory (CD-ROM), a USB flash drive, a removable hard disk, or the like) or in a network and includes several instructions for instructing a computing device (which may be a personal computer, a server, a terminal device, a network device, or the like) to perform the methods described in the implementations of the disclosure.

In an exemplary embodiment of the disclosure, a computer-readable storage medium is further provided, storing computer-readable instructions, the computer-readable instructions, when executed by a processor of a computer, causing the computer to perform the methods described in the foregoing method embodiments. In an example, the computer-readable instructions may be deployed to be executed on a computing device, or deployed to be executed on a plurality of computing devices at the same location, or deployed to be executed on a plurality of computing devices that are distributed in a plurality of locations and interconnected by using a communication network. A plurality of computing devices that are distributed in a plurality of locations and interconnected by using a communication network may form a blockchain system.

According to an embodiment of the disclosure, a program product for performing the method in the foregoing method embodiments is further provided. The program product may use a portable CD-ROM and include a program code, and may be run on a terminal device, for example, a personal computer. However, the program product in the present disclosure is not limited thereto. In this specification, the computer-readable storage medium may be any tangible medium including or storing a program, and the program may be used by or used in combination with an instruction execution system, an apparatus, or a device.

The program product may be any combination of one or more readable mediums. A readable medium may be a readable signal medium or a computer-readable storage medium. The computer-readable storage medium may be, for example, but is not limited to, an electric, magnetic, optical, electromagnetic, infrared, or semi-conductive system, apparatus, or component, or any combination thereof. More specific examples (non-exhaustive list) of the computer-readable storage medium may include: an electrical connection having one or more wires, a portable disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination thereof.

The computer-readable signal medium may include a data signal being in a baseband or transmitted as a part of a carrier, which carries readable program code. A data signal propagated in such a way may assume a plurality of forms, including, but not limited to, an electromagnetic signal, an optical signal, or any appropriate combination thereof. The readable signal medium may alternatively be any readable medium other than the computer-readable storage medium. The readable medium may be used for sending, propagating, or transmitting a program used by or used in combination with an instruction execution system, an apparatus, or a device.

The program code included in the readable storage medium may be transmitted by using any suitable medium, including but not limited to a wireless medium, a wired medium, an optical cable, RF, or any appropriate combination thereof.

The program code used for performing the operations of the present disclosure may be written by using one or more programming languages or a combination thereof. The programming languages include an object-oriented programming language, for example, JAVA and C++, and also include a conventional procedural programming language, for example, “C” or similar programming languages. The program code may be completely executed on a user computing device, partially executed on a user device, executed as an independent software package, partially executed on a user computing device and partially executed on a remote computing device, or completely executed on a remote computing device or server. In case of the remote computing device, the remote computing device may be connected to the computing device of a user by using any network including a LAN or a WAN, or may be connected to an external computing device (for example, connected to the external computing device through the Internet by using an Internet service provider).

Although a plurality of modules or units of a device configured to perform actions are discussed in the foregoing detailed description, such division is not mandatory. Actually, according to the implementations of the disclosure, the features and functions of two or more modules or units described above may be specifically implemented in one module or unit. On the contrary, the features and functions of one module or unit described above may be further divided to be embodied by a plurality of modules or units.

In addition, although the various operations of the method in the disclosure are described in a specific order in the accompanying drawings, this does not require or imply that the operations are bound to be performed in the specific order, or all the operations shown are bound to be performed to achieve the expected result. Additionally or alternatively, some operations may be omitted, a plurality of operations may be combined into one operation for execution, and/or one operation may be decomposed into a plurality of operations for execution, and the like.

According to the foregoing descriptions of the implementations, a person skilled in the art may readily understand that the exemplary implementations described herein may be implemented by using software, or may be implemented by combining software and necessary hardware. Therefore, the technical solutions of the implementations of the disclosure may be implemented in a form of a software product. The software product may be stored in a non-volatile computer-readable storage medium (which may be a CD-ROM, a USB flash drive, a removable hard disk, or the like) or on the network, including several instructions for instructing a computing device (which may be a personal computer, a server, a mobile terminal, a network device, or the like) to perform the methods according to the implementations of the disclosure.

At least one of the components, elements, modules or units described herein may be embodied as various numbers of hardware, software and/or firmware structures that execute respective functions described above, according to an example embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the block diagrams, communication between the components, elements or units may be performed through the bus. Functional aspects of the above embodiments may be implemented in algorithms that execute on one or more processors. Furthermore, the components, elements or units represented by a block or processing operations may employ any number of related art techniques for electronics configuration, signal processing and/or control, data processing and the like.

After considering the specification and practicing the present disclosure, a person skilled in the art may easily conceive of other implementations of the disclosure. The disclosure is intended to cover any variations, uses, or adaptive changes of the disclosure. These variations, uses, or adaptive changes follow the general principles of the disclosure and include common general knowledge or common technical means in the art, which are not disclosed in the disclosure. The specification and the embodiments are merely considered as examples, and the actual scope and the spirit of the disclosure are pointed out by the following claims.

What is claimed is:

1. A method for data processing, performed by at least one processor, the method comprising:
generating unique identification information associated with a user account;
transmitting the unique identification information to the user account;
receiving, from a server associated with an institution which verifies identity information corresponding to the user account, the unique identification information and a non-payment service request related to the user account; and
identifying the user account based on the unique identification information, and providing the user account with a non-payment service based on the non-payment service request.

2. The method according to claim 1, wherein the non-payment service request comprises an account activation request, and
the providing the user account with the non-payment service comprises: providing the user account with an account activation service based on the account activation request.

3. The method according to claim 2, further comprising:
receiving, from the server, a user security level of the user account, that is determined by the institution based on the identity information corresponding to the user account; and
configuring an account permission based on the user security level for the user account.

4. The method according to claim 1, wherein the non-payment service request comprises an account top-up request for the user account that is activated, and
the providing the user account with the non-payment service comprises: providing the user account with an account top-up service based on the account top-up request.

5. The method according to claim 4, wherein the user account is configured with an account permission; and
the providing the user account with the non-payment service comprises:
verifying validity of the account top-up request based on the account permission; and
providing the user account with the account top-up service for the user account based on verification that the account top-up request is valid.

6. The method according to claim 5, wherein the providing the user account with the account top-up service comprises:
generating a top-up order based on the account top-up request, and transmitting the top-up order to the server;
receive, from the server, response information in response to the top-up order; and
providing the user account with the account top-up service based on the response information.

7. The method according to claim 1, wherein the providing the user account with the non-payment service comprises:
receiving, from the server, user identity information corresponding to the user account; and
providing the user account with the non-payment service based on the user identity information and the non-payment service request.

8. The method according to claim 7, wherein the non-payment service request comprises an account activation request, and
the providing the user account with the non-payment service comprises:
storing the user identity information, and associating the user identity information with the user account; and
providing the user account with an account activation service based on the account activation request.

9. The method according to claim 8, further comprising:
configuring a user security level for the user account based on the user identity information; and
configuring an account permission based on the user security level for the user account.

10. The method according to claim 9, wherein an institution security level is pre-configured for the institution; and
the configuring the user security level comprises: configuring the user security level for the user account based on the institution security level and the user identity information.

11. The method according to claim 7, wherein the non-payment service request comprises an account top-up request for the user account that is activated, and
the providing the user account with the non-payment service based on the user identity information and the non-payment service request comprises: providing the user account with an account top-up service based on the user identity information and the account top-up request.

12. The method according to claim 11, wherein the user account is configured with an account permission; and
the providing the user account with the account top-up service comprises:
verifying the user identity information based on information that the user account has been associated with;
verifying validity of the account top-up request based on the account permission; and
providing the user account with the account top-up service based on the user identity information being verified and the account top-up request being valid.

13. The method according to claim 12, wherein the providing the user account with the account top-up service comprises:
generating a top-up order based on the account top-up request, and transmitting the top-up order to the server;
receiving, from the server, response information in response to the top-up order; and
providing the user account with the account top-up service based on the response information.

14. An apparatus for data processing, comprising:
at least one memory configured to store program code; and
at least one processor configured to read the program code and operate as instructed by the program code, the program code comprising:
generation code configured to cause the at least one processor to generate unique identification information associated with a user account, and transmit the unique identification information to the user account;
acquisition code configured to cause the at least one processor to receive, from a server associated with an institution which verifies identity information corresponding to the user account, the unique identification information and a non-payment service request related to the user account; and
service providing code configured to cause the at least one processor to identify the user account, and provide the user account with a non-payment service based on the non-payment service request.

15. The apparatus according to claim 14, wherein the non-payment service request comprises an account activation request, and
the service providing code is configured to cause the at least one processor to:
receive, from the server, a user security level of the user account, the user security level indicating a credibility of the user account based on identity information corresponding to the user account; and
configure an account permission based on the user security level for the user account.

16. The apparatus according to claim 14, wherein the non-payment service request comprises an account top-up request for the user account that is activated;
the user account is configured with an account permission; and
the service providing code is configured to cause the at least one processor to:
verifying validity of the account top-up request based on the account permission; and
providing the user account with the an account top-up service for the user account based on verification that the account top-up request is valid.

17. The apparatus according to claim 16, wherein the service providing code is configured to cause the at least one processor to:
generate a top-up order based on the account top-up request, and transmitting the top-up order to the server;
receive, from the server, response information in response to the top-up order; and
provide the user account with the account top-up service based on the response information.

18. The apparatus according to claim 14, wherein the service providing code is configured to cause the at least one processor to:
receive, from the server, user identity information corresponding to the user account; and
provide the user account with the non-payment service based on the user identity information and the non-payment service request.

19. An electronic device for data processing, comprising:
a memory, storing computer-readable instructions; and
a processor, reading the computer-readable instructions stored in the memory to perform the method for data processing according to claim 1.

20. A non-transitory computer-readable storage medium, storing instructions executable by at least one processor to perform:
generating unique identification information associated with a user account;
transmitting the unique identification information to the user account;
receiving, from a server associated with an institution which verifies identity information corresponding to the user account, the unique identification information and a non-payment service request related to the user account; and
identifying the user account based on the unique identification information, and providing the user account with a non-payment service based on the non-payment service request.
